(19) United States
(12) Patent Application Publication
(10) Pub. No.: US 2005/0259685 A1
(43) Pub. Date: Nov. 24, 2005

(54) Dual speed interface between media access control unit and physical unit

(76) Inventors: Luke Chang, Aloha, OR (US); Ilango S. Ganga, Cupertino, CA (US)

Correspondence Address: Cory G. Claassen;BLAKELY, SOKOLOFF, TAYLOR & ZAFMAN LLP, Seventh Floor, 12400 Wilshire Boulevard, Los Angeles, CA, 90025, US

(21) Appl. No.: 10/851,002

(22) Filed: May 21, 2004

(51) Int. Cl. H04J 3/22

(52) U.S. Cl. 370/469; 370/535

(57) ABSTRACT

An apparatus, system, and method to provide a dual speed bi-directional link between a media access control (“MAC”) unit and a physical (“PHY”) unit. The MAC unit controls access to a physical medium and the PHY unit couples to the physical medium. A bi-directional link couples first transmit data paths (“TXDPs”) and first receive data paths (“RXDPs”) of the MAC unit to second TXDPs and second RXDPs of the PHY unit. The MAC and PHY units configured to route data along all of the first and second TXDPs and RXDPs during fast speed operation and to route the data along one of the first and second TXDPs and one of the first and second RXDPs during the slow speed operation.

### TECHNICAL FIELD

This disclosure relates generally to networking, and in particular but not exclusively, relates to a media access control (“MAC”) unit to physical (“PHY”) unit interface for coupling to 10GBASE-T and 1000BASE-T networks.

### BACKGROUND INFORMATION

Computer networks are becoming an increasingly important aspect of personal and professional life. Networks are used for a wide variety of services including audio, video, and data transfer. As such there is a need for ever-faster networks providing greater bandwidth. Gigabit Ethernets (“GigE”) have been developed to service this need for bandwidth. The Institute of Electrical and Electronics Engineers (“IEEE”) Standard 802.3ab-1999 defines a 1000 Mbps Ethernet (1000BASE-T) that operates over a four pair twisted copper Category 5 wire. The IEEE Standard 802.3ae-2002 defines a 10 Gbps Ethernet (10GBASE-X/R) that operates over a fiber cable.

Optical fiber networks have been developed to operate at the 10 Gbps bandwidth using a 10 Gbps fiber interface (XFI) or a 10 Gbps attachment unit interface (XAUI) having media access control (“MAC”) devices that are coupled directly to an optics devices to convert the electrical signals to optical signals for transmission over the optical fiber network. However, current optics devices do not have the intelligence necessary for dual speed use.

Currently there are no dual mode devices capable of interchangeably coupling to both 1 Gbps and a 10 Gbps networks. Such crossover devices are available for coupling to 10 Mbps and 100 Mbps Ethernets. These devices are referred to as 10/100 Ethernet devices. However, there is a market need for such crossover devices operating at the 1 Gbps/10 Gbps bandwidths.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating the architecture of a dual speed network interface, in accordance with an embodiment of the present invention.

FIG. 2 is a block diagram illustrating a dual speed network interface, in accordance with an embodiment of the present invention.

FIG. 3 is a block diagram illustrating a dual speed network interface having a two lane data path coupling a media access control (“MAC”) unit to a physical (“PHY”) unit, in accordance with an embodiment of the present invention.

FIG. 4A is a flow chart illustrating a process to transition from a fast speed to a slow speed initiated by a MAC unit of a dual speed network interface, in accordance with an embodiment of the present invention.

FIG. 4B is a flow chart illustrating a process to transition from a fast speed to a slow speed initiated by a PHY unit of a dual speed network interface, in accordance with an embodiment of the present invention.

FIG. 5A is a flow chart illustrating a process to transition from a slow speed to a fast speed initiated by a MAC unit of a dual speed network interface, in accordance with an embodiment of the present invention.

FIG. 5B is a flow chart illustrating a process to transition from a slow speed to a fast speed initiated by a PHY unit of a dual speed network interface, in accordance with an embodiment of the present invention.

FIG. 6 is a flow chart illustrating a start up sequence of a dual speed network interface to determine a link speed to a physical medium, in accordance with an embodiment of the present invention.

FIG. 7 is a block diagram illustrating a system including multiple network devices coupled to a physical medium via dual speed network interfaces, in accordance with an embodiment of the present invention.

### DETAILED DESCRIPTION

Embodiments of a system and method for a dual speed network interface capable of interfacing with 1000BASE-T and 10GBASE-T networks are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

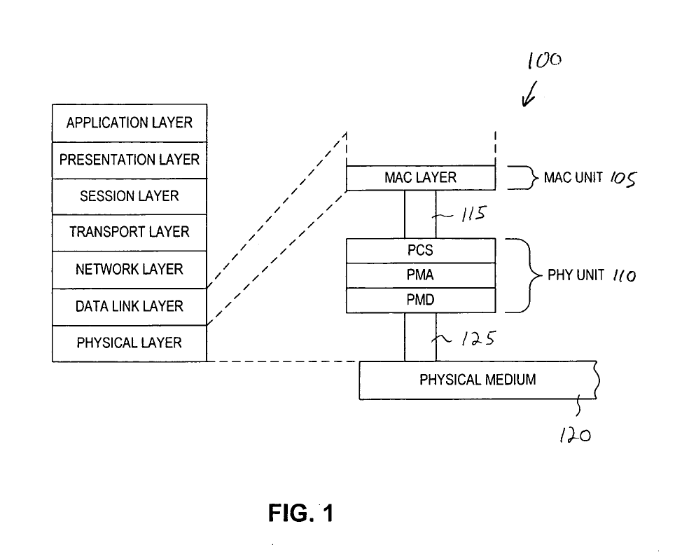

FIG. 1 is a block diagram illustrating the architecture of a dual speed network interface 100, in accordance with an embodiment of the present invention. The illustrated embodiment of dual speed network interface 100 includes a media access control (“MAC”) unit 105 and a physical (“PHY”) unit 110.

With reference to the seven layer Open System Interconnect (“OSI”) Reference Model developed by the International Standards Organization (“ISO”), MAC unit 105 implements MAC layer functionality. The MAC layer is a sublayer of the data link layer. The data link layer is primarily concerned with transforming a raw transmission facility into a communication line free of undetected transmission errors for use by the network layer. The data link layer accomplishes this task by breaking input data into data frames, transmitting the data frames sequentially, and processing acknowledgement frames. The MAC sublayer provides additional functionality concerned with controlling access to broadcast networks (e.g., Ethernet). In the case of Ethernet architecture, the MAC sublayer may implement a Carrier Sense Multiple Access with Collision Detection (“CSMA/CD”) protocol.

MAC unit 105 is coupled to PHY unit 110 via a bi-directional link 115 to provide a data path between MAC unit 105 and PHY unit 110. Bi-directional link 115 is often referred to as a Media Independent Interface (“MII”), an xMII in the case of implementations of 100 Mbps or higher, X attachment unit interface (“XAUI”) in the case of 10 Gbps implementations, or X fiber interface (“XFI”) in the case of dual path 10 Gbps implementations.

PHY unit 110 implements physical layer functionality. The physical layer is primarily concerned with transmitting raw bits over physical media 120, which may be some form of network. PHY unit 110 is coupled to physical media 120 via a media dependent interface (“MDI”) 125. PHY unit 110 may further implement the functionality of various sublayers of the physical layer including a physical coding sublayer (“PCS”), a physical medium attachment (“PMA”) layer, and a physical medium dependent (“PMD”) layer.

Physical media 120 may include an optical fiber, a twisted pair conductor, or the like. In one embodiment, physical medium 120 is a four pair twisted conductor, such as copper, conforming to a Category 5, 6, 7 or the like cable. In this four pair twisted conductor embodiment, PHY unit 110 converts digital data received from MAC unit 105 (e.g., 1000BASE-X, 10GBASE-X) into analog symbols (e.g., 1000BASE-T, 10GBASE-T) for transmission over physical medium 120. For example, PHY unit 110 may encode the digital data using Manchester encoding or the like. Physical medium 120 may operate at any number of bandwidths including, for example, 1 Gbps and 10 Gbps. In one embodiment, physical medium 120 is capable of operating at both 1 Gbps and 10 Gbps using the 1000BASE-T and 10GBASE-T standards.

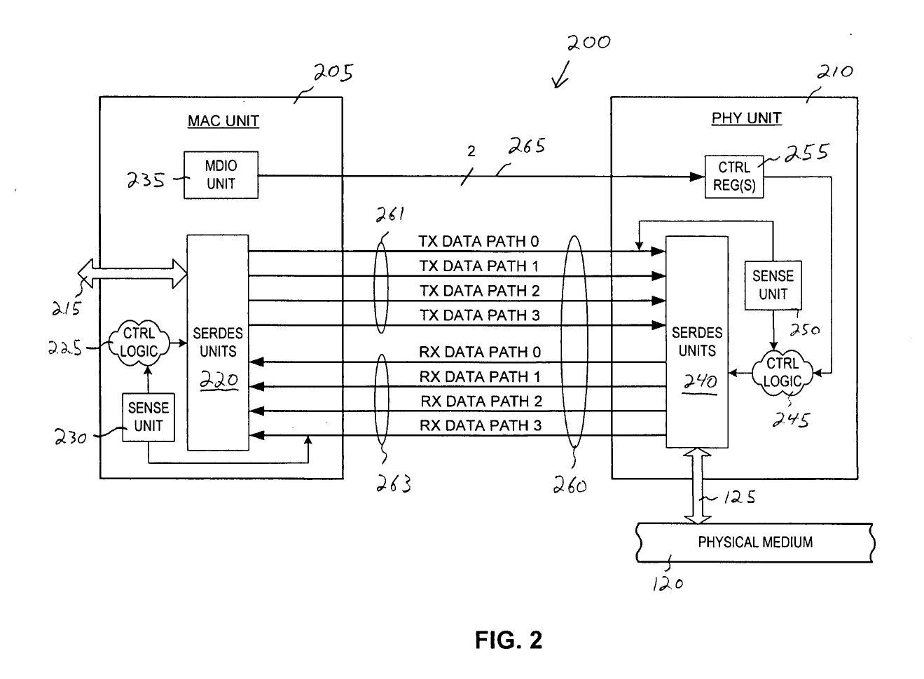

FIG. 2 is a block diagram illustrating a dual speed network interface 200, in accordance with an embodiment of the present invention. Dual speed network interface 200 represents one embodiment of dual speed network interface 100. The illustrated embodiment of dual speed network interface 200 includes a MAC unit 205 and a PHY unit 210. MAC unit 205 includes a data input/output (“I/O”) 215, serializer/deserializer (“SERDES”) units 220, control logic 225, a sense unit 230, and a management data input/output (“MDIO”) unit 235. PHY unit 210 includes SERDES units 240, control logic 245, a sense unit 250, control registers 255, and MDI 125. MAC unit 205 is coupled to PHY unit 210 with bi-directional link 260 having four transmit data paths (“TXDPs”) 261 (e.g., TXDP 0, 1, 2, 3) and four receive data paths (“RXDPs”) 263 (e.g., RXDP 0, 1, 2, 3). MDIO unit 235 is further communicatively coupled to control registers 255 via a two-lane MDIO bus 265.

The components of dual speed network interface 200 are interconnected as follows. SERDES units 220 are coupled to data I/O 215 to send and receive data thereon. SERDES units 220 serialize data receive from data I/O 215 onto each of TXDPs 261 and deserialize data received from RXDPs 263 onto data I/O 215. Data I/O 215 may be a data bus of a computer, such as a peripheral component interconnect (“PCI”) bus, PCI Express bus, or the like. Data I/O 215 represents any I/O path providing data thereon and typically will be a parallel data path wider than each direction of bi-directional link 260. SERDES units 240 serialize the data received on TXDPs 261 for transmission over physical medium 120. SERDES units 240 further deserialize data received from physical medium 120 for transmission over RXDPs 263 to MAC unit 205.

Sense unit 230 is coupled to each of RXDPs 263 to sense whether RXDPs 263 are currently in an idle state or an active state. Sense unit 230 is further coupled to sense whether RXDPs 263 are operating in a slow speed or a fast speed. Similarly, sense unit 250 is coupled to each of TXDPs 261 to sense whether TXDPs 261 are currently in an idle state or an active state and whether TXDPs 261 are operating in a slow speed or a fast speed.

Control logic 225 is coupled to sense unit 230 to receive one or more signals indicating whether RXDPs 263 are idle or active and operating at the slow speed or the fast speed. In turn, control logic 225 is coupled to SERDES units 220 to instruct SERDES units 220 when to idle (e.g., disable) or activate (e.g., enable) TXDPs 261 and when to transition TXDPs 261 from the slow speed to the fast speed or visa versa. How and when control logic 225 instructs SERDES units 220 is described in detail below.

Control logic 245 is similarly coupled to sense unit 250 to receive one or more signals indicating whether TXDPs 261 are idle or active and operating at the slow speed or the fast speed. Control logic is further coupled to SERDES units 240 to instruct SERDES units 240 when to idle or activate RXDPs 263 and when to transition RXDPs 263 from the slow speed to the fast speed or visa versa. Control logic 245 is further coupled to control registers 255 to access the contents of control registers 255 and act accordingly. For example, control registers 255 may contain control data indicating what speed (e.g., slow speed or fast speed) PHY unit 210 should startup at upon a reset or other power cycle event. MDIO unit 235 is coupled to control registers 255 via MDIO bus 265 to write control data thereto. How and when control logic 245 instructs SERDES units 240 is described in detail below.

It should be appreciated that the illustrated embodiments of MAC unit 205 and PHY unit 210 may include other known components not illustrated. One of ordinary skill in the art having the benefit of the instant description will understand these known components have been excluded from FIG. 2 for the sake of clarity so as not to detract from the instant description.

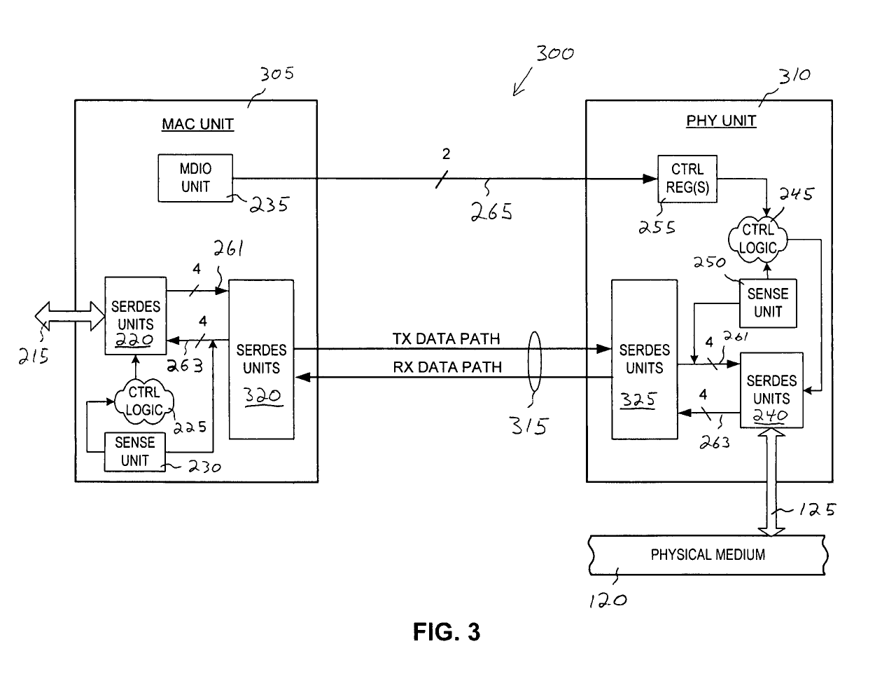

FIG. 3 is a block diagram illustrating a dual speed network interface 300, in accordance with an embodiment of the present invention. Dual speed network interface 300 represents another embodiment of dual speed network interface 100. The illustrated embodiment of dual speed network interface 300 includes a MAC unit 305 and a PHY unit 310 coupled together with a bi-directional link 315.

Dual speed network interface 300 is similar to dual speed network interface 200 with the exception that bi-directional link 315 is a two-lane data path as opposed to an eight-lane data path, and MAC unit 305 includes an additional SERDES unit 320 and PHY unit 310 includes an additional SERDES unit 325. SERDES units 320 and 325 function to further multiplex the eight data paths of TXDPs 261 and RXDPs 263 onto the two data paths of bi-directional link 315. Coupling the data paths of MAC unit 305 to the data paths of PHY unit 310 using only two data paths saves valuable real estate on a circuit board, in an embodiment where MAC unit 305 and PHY unit 310 are discrete components, or on a die, in an embodiment where MAC unit 305 and PHY unit 310 are components of an integrated circuit. In one embodiment, bi-directional link 315 operates using XFI protocols while operating in the fast speed mode of operation (e.g., 10 Gbps).

The processes explained below are described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like. The order in which some or all of the process blocks appear in each process should not be deemed limiting. Rather, one of ordinary skill in the art having the benefit of the present disclosure will understand that some of the process blocks may be executed in a variety of orders not illustrated.

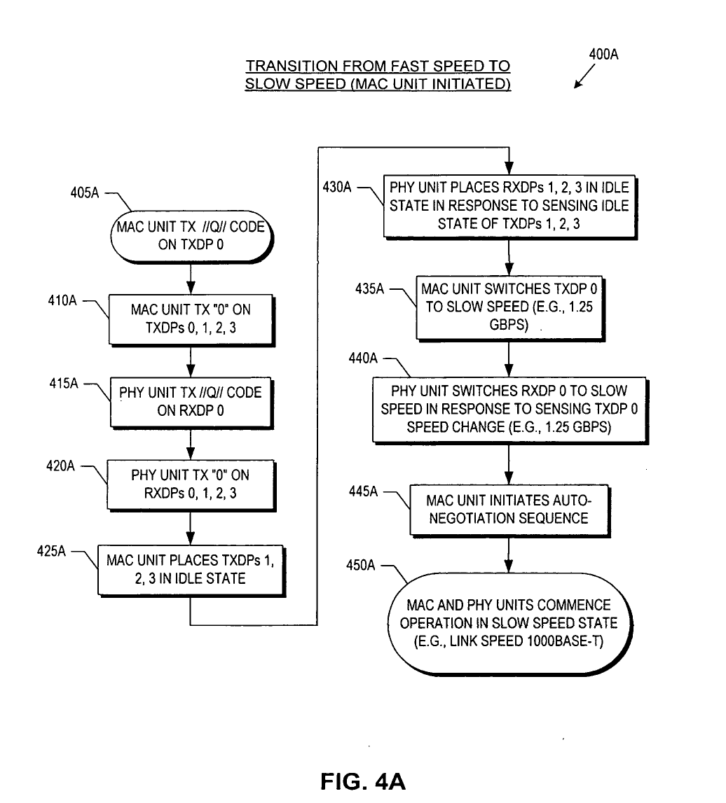

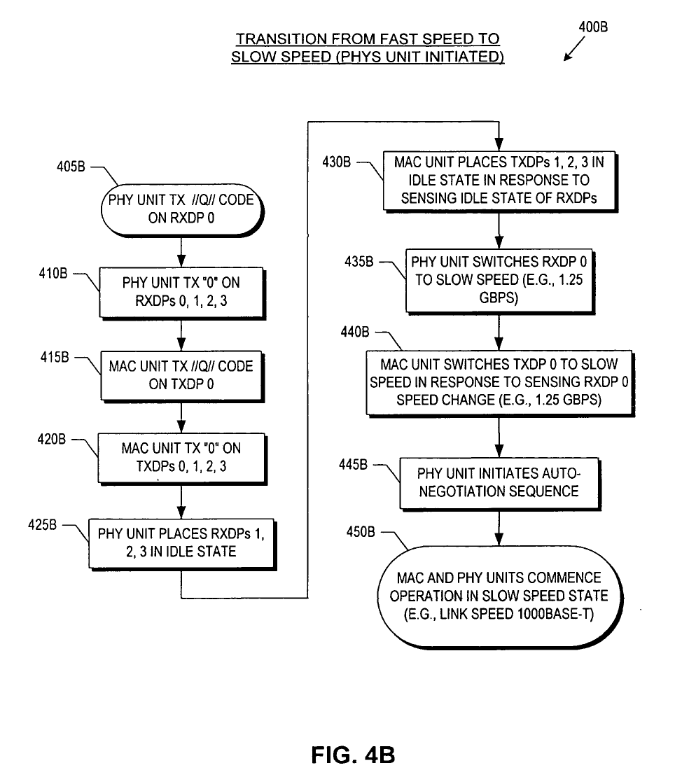

FIG. 4A is a flow chart illustrating a process 400A to transition dual speed network interface 200 from a fast speed to a slow speed initiated by MAC unit 205, in accordance with an embodiment of the present invention. Although process 400A (as well as processes 400B, 500A, 500B, and 600) is described with reference to dual speed network interface 200 for the sake of clarity, it should be appreciated that it is equally applicable to embodiments of dual speed network interfaces 100 and 300.

Beginning with a process block 405A, dual speed network interface 200 is operating in a fast speed mode of operation. In one embodiment, the fast speed mode of operation provides a link speed between PHY unit 210 and physical medium 120 of 10 Gbps (e.g., 10GBASE-T). In process block 405A, MAC unit 205 transmits a link status code on TXDP 0 to PHY unit 210. The link status code is an indication that MAC unit 205 is about to break link (e.g., change the link speed with physical medium 120). In one embodiment, the link status code is a //Q// code defined in clause 48 of the IEEE Standard 802.3ae™-2002. After transmitting the link status code, MAC unit transmits “0” on each of TXDPs 1, 2, 3 (process block 410A).

In response to receiving the link status code on TXDP 0, PHY unit 210 acknowledges receipt of the link status code by transmitting a link status code (e.g., the //Q// code) back on RXDP 0 (process block 415A). In a process block 420A, PHY unit 210 also transmits “0” on each of RXDPs 1, 2, 3.

Upon receipt of the link status code transmitted by PHY unit 210 on RXDP 0, MAC unit 205 places TXDPs 1, 2, 3 into an idle state (process block 425A). In one embodiment, MAC unit 205 places TXDPs 1, 2, 3 into the idle state by disabling the corresponding SERDES units 220 coupling to TXDPs 1, 2, 3. In one embodiment, an idle state places the peak-to-peak amplitude output by SERDES units 220 coupled to TXDPs 1, 2, 3 to 50 mV or less. Upon sensing that TXDPs 1, 2, 3 have entered the idle state, PHY unit 210 places RXDPs 1, 2, 3 into the idle state as well (process block 430A).

In a process block 435A, MAC unit 205 switches the output of the one of SERDES units 220 coupled to TXDP 0 to the slow speed. In one embodiment, TXDP 0 transitions down to 1.25 Gbps. Transitioning TXDP 0 to 1.25 Gbps provides a link speed between PHY unit 210 and physical medium 120 of 1 Gbps. The additional 0.25 Gbps of bandwidth provided by TXDP 0 is consumed by error detection and recovery data added by the PCS layer of PHY unit 210, illustrated in FIG. 1. Upon sensing the speed change of TXDP 0, PHY unit 210 switches the output of the one of SERDES units 240 coupled to RXDP 0 to the slow speed (process block 440A). In one embodiment, RXDP 0 is transitioned down to 1.25 Gbps.

Once both TXDP 0 and RXDP 0 are operating in the slow speed and TXDP 1, 2, 3 and RXDP 1, 2, 3 have been placed in the idle state (e.g., disabled), MAC unit 205 initiates an auto-negotiation sequence to align signal edges between SERDES units 220 and SERDES units 240 coupled to TXDP 0 and RXDP 0 (process block 445A). In one embodiment, the auto-negotiation sequence is executed by the auto-negotiation (“AN”) function defined in clause 37 of the IEEE Standard 802.3-2002. The AN function enables two devices (e.g., SERDES units 220 and 240) sharing a link segment (e.g., TXDP 0 and RXDP 0) to advertise modes of operation to their link partner and to detect operation modes advertised by their link partner. Once the auto-negotiation sequence has completed, MAC unit 205 and PHY unit 210 may commence regular slow speed operation to transmit and receive data over physical medium 120 (process block 450A).

FIG. 4B is a flow chart illustrating a process 400B to transition dual speed network interface 200 from the fast speed to the slow speed initiated by PHY unit 210, in accordance with an embodiment of the present invention. Process 400B is similar to process 400A with the exception that the roles of MAC unit 205 and PHY unit 205 are switched. Like reference numerals refer to like process blocks. Process 400B enables PHY unit 210 to detect a speed transition from a fast link speed to a slow link speed on physical medium 120 and in response initiate a transition from the fast speed to the slow speed with MAC unit 205.

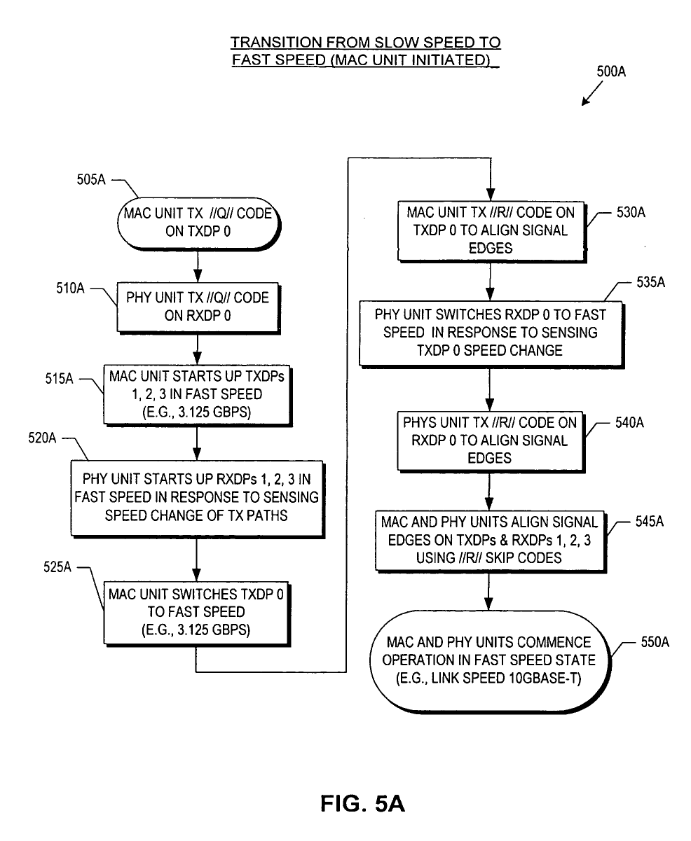

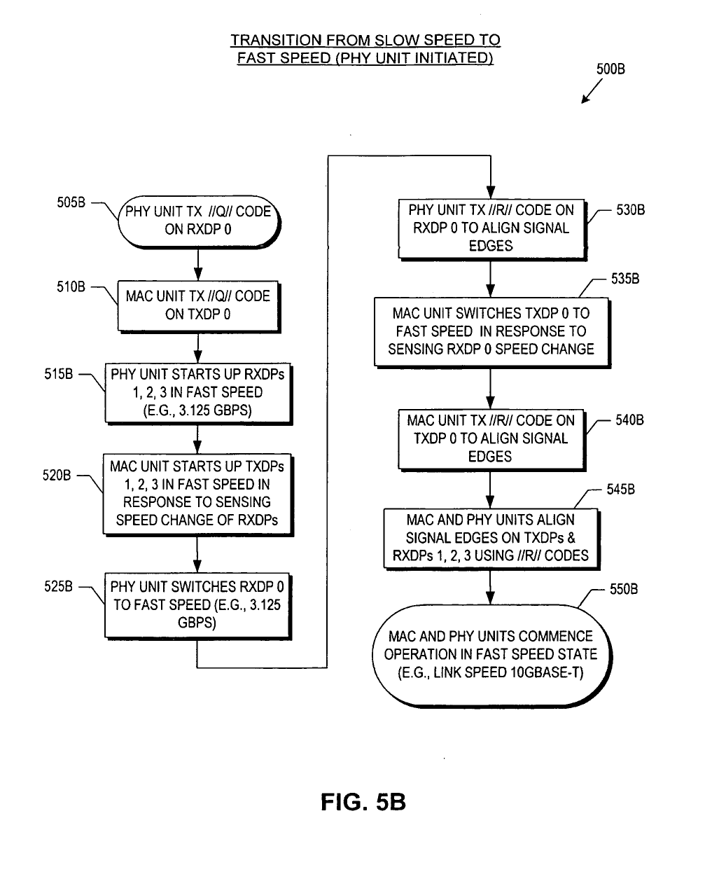

FIG. 5A is a flow chart illustrating a process 500A to transition dual speed network interface 200 from the slow speed to the fast speed initiated by MAC unit 205, in accordance with an embodiment of the present invention. Beginning with a process block 505A, dual speed network interface 200 is operating in a slow speed mode of operation (e.g., 1 Gbps link speed with physical medium 120). In process block 505A, MAC unit 205 transmits a link status code on TXDP 0 to PHY unit 210. In one embodiment, the link status code is the //Q// code defined in clause 48 of the IEEE Standard 802.3ae™-2002.

In a process block 510A, PHY unit 210 acknowledges the link status code received on TXDP 0 by transmitting a link status code on RXDP 0 back to MAC unit 205. In one embodiment, the acknowledgement link status code is also the //Q// code.

In a process block 515A, upon receipt of the acknowledge link status code on RXDP 0, MAC unit 210 starts up TXDPs 1, 2, 3, currently in the idle state, into the fast speed mode of operation. In one embodiment, TXDPs 1, 2, 3 are transitioned into the fast speed by enabling the outputs of SERDES units 220 coupled to TXDPs 1, 2, 3. In one embodiment, TXDPs 1, 2, 3 are operated at 3.125 Gbps while operating in the fast speed. Operating all four TXDPs 261 at 3.125 Gbps provides a link speed to physical medium 120 of 10 Gbps. The additional bandwidth provided by TXDPs 261 is consumed by error detection and recovery data added by the PCS layer of PHY unit 210, illustrated in FIG. 1.

In a process block 520A, upon sensing that TXDPs 1, 2, 3 have become active and transitioned to the fast speed, PHY unit 205 starts up RXDPs 1, 2, 3 into the fast speed. Subsequently, sensing that RXDPs 1, 2, 3 have become active in the fast speed, MAC unit 205 switches TXDP 0 from the slow speed to the fast speed (e.g., 3.125 Gbps) (process block 525A). After transitioning TXDP 0 to the fast speed, MAC unit 205 transmits a synchronization code to PHY unit 210 on TXDP 0 to initiate an operation to synchronize the ones of SERDES units 220 and 240 coupled to TXDP 0. The synchronization code signifies commencement of an operation to de-skew and align signal edges between SERDES units 220 and 240. In one embodiment, the synchronization code is an //R// code defined in clause 48 of the IEEE Standard 802.3ae™-2002.

In a process block 535A, PHY unit 210 switches RXDP 0 to the fast speed in response to sensing the speed change on TXDP 0. In a process block 540A, PHY unit 210 transmits a synchronization code (e.g., the //R// code) on RXDP 0 to initiate the synchronization operation on RXDP 0. In process block 545A, MAC unit 205 and PHY unit 210 proceed to de-skew and align the signal edges on each of TXDP 1, 2, 3 ad RXDP 1, 2, 3. Once the entire bi-directional link 260 has been transitioned to the fast speed and the data paths synchronized, MAC unit 205 and PHY unit 210 commence regular fast speed operation to communicate over physical medium 120 in the fast speed state (e.g., 10GBASE-T). In one embodiment, MAC unit 205 and PHY unit 210 communicate over bi-directional link 260 during the fast speed mode of operation using 10 Gbps Attachment Unit Interface (XAUI) protocols.

FIG. 5B is a flow chart illustrating a process 500B to transition dual speed network interface 200 from the slow speed to the fast speed initiated by PHY unit 210, in accordance with an embodiment of the present invention. Process 500B is similar to process 500A with the exception that the roles of MAC unit 205 and PHY unit 205 are switched. Like reference numerals refer to like process blocks. Process 500B enables PHY unit 210 to detect a speed transition from a slow link speed to a fast link speed on physical medium 120 and in response initiate a transition from the slow speed to the fast speed with MAC unit 205.

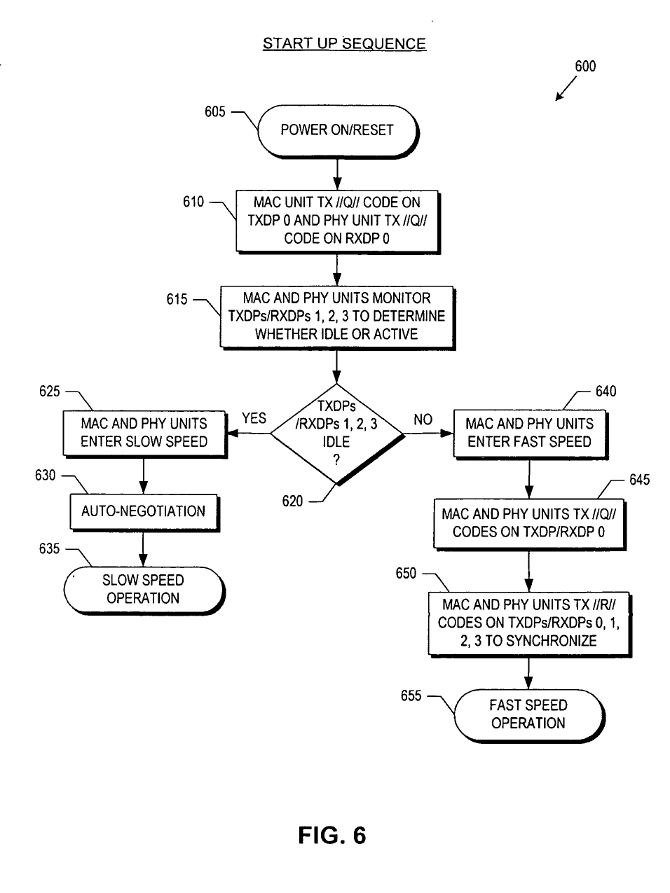

FIG. 6 is a flow chart illustrating a process 600 to startup dual speed network interface 200 after a reset or power cycle, in accordance with an embodiment of the present invention. In a process block 605, dual speed network interface 200 is reset or otherwise power cycled. In a process block 610, both MAC unit 205 and PHY unit 210 transmit the link status code (e.g., the //Q// code) on TXDP 0 and RXDP 0, respectively. In process block 615, MAC unit 205 monitors RXDPs 1, 2, 3 using sense unit 230 to determine whether RXDPs 1, 2, 3 are idle or active. Similarly, PHY unit 210 monitors TXDPs 1, 2, 3 using sense unit 250 to determine whether TXDPs 1, 2, 3 are idle or active. TXDPs 1, 2, 3 and RXDPs 1, 2, 3 may be idle or active depending upon a number of factors. For example, PHY unit 210 may be set using control registers 255 to startup with RXDPs 0, 1, 2, 3 operating either in the slow speed or the fast speed depending upon the link speed with physical medium 120. Alternatively, PHY unit 210 may be set using control registers 255 to startup in one of the slow speed or the fast speed without regard to the link speed with physical medium 120.

In a decision block 620, if RXDPs 1, 2, 3 and/or TXDPs 1, 2, 3 are idle, then process 600 continues to a process block 625. In process block 625, both MAC unit 205 and PHY unit 210 enter the slow speed. Subsequently, MAC unit 205 and PHY unit 210 auto-negotiate to synchronize bi-directional link 260 (process block 630) and commence regular slow speed operation to communicate across physical medium 120 (process block 635).

Returning to decision block 620, if RXDPs 1, 2, 3 and/or TXDPs 1, 2, 3 are active, then process 600 continues to a process block 640. In process block 640, both MAC unit 205 and PHY unit 210 enter the fast speed. Subsequently, MAC unit 205 and PHY unit 210 transmit link status codes (e.g., the //Q// code) on TXDP 0 and RXDP 0, respectively process block 645) and then synchronization codes (e.g., the //R// code) are transmitted on TXDP 0, 1, 2, 3 and RXDP 0, 1, 2, 3, respectively, to synchronize SERDES units 220 with SERDES units 240 (process block 650). In a process block 655, dual speed network interface 200 commences regular fast speed operation to communicate across physical medium 120.

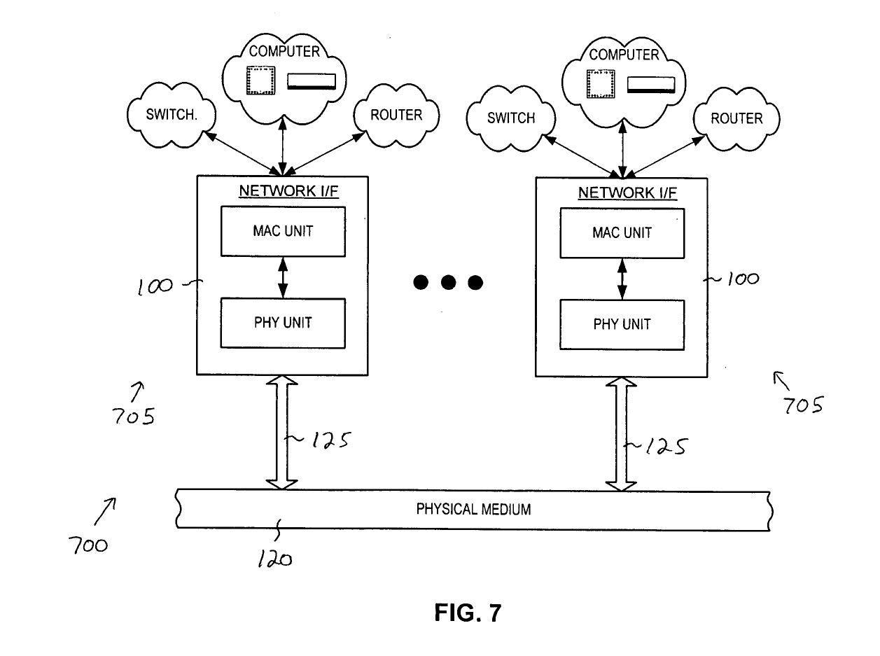

FIG. 7 is a block diagram illustrating a system 700 including multiple network devices 705 coupled to physical medium 120 using dual speed network interfaces 100, in accordance with an embodiment of the present invention. As discussed above, dual speed network interfaces 100 may be implemented as either one of dual speed network interface 200 or 300.

System 700 illustrates how dual speed network interfaces 100 may be used to couple any number of devices to physical medium 120, including for example, a switch, a router, a computer including a central processing unit (“CPU”) and system memory, and the like. The computer may represent a client or a server. Dual speed network interfaces 100 enable a single device to be coupled to either a slow speed network (e.g., 1 Gbps) or a fast speed network (e.g., 10 Gbps) without having to replace or switch the network interface. Furthermore, dual speed network interfaces 100 enable the speed of physical medium 120 to be changed during operation without having to disconnect network devices 705. Accordingly embodiments of the present invention provide a dual speed network interface capable of operating at 1 and 10 Gbps over a four pair twisted conductor using 1000BASE-T and 10GBASE-T Gigabit Ethernet protocols.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus, comprising:
a media access control (“MAC”) unit to control access to a physical medium, the MAC unit including first transmit data paths (“TXDPs”) and first receive data paths (“RXDPs”);
a physical (“PHY”) unit to couple to the physical medium to transmit data over the physical medium, the PHY unit including second TXDPs and second RXDPs; and
a bi-directional link coupling the first TXDPs and RXDPs of the MAC unit to the second TXDPs and RXDPs of the PHY unit, respectively, the MAC and PHY units configured to route the data along all of the first and second TXDPs and RXDPs during a first operation and to route the data along only one of the first and second TXDPs and only one of the first and second RXDPs during a second operation.

2. The apparatus of claim 1, wherein the MAC unit includes a first sense unit coupled to each of the first RXDPs to sense when the PHY unit has placed some of the second RXDPs into an idle state during the second operation and coupled to signal the MAC unit to place some of the first TXDPs into the idle state in response.

3. The apparatus of claim 2, wherein the PHY unit includes a second sense unit coupled to each of the second TXDPs to sense when the MAC unit has placed some of the first TXDPs into the idle state during the second operation and coupled to signal the PHY unit to place some of the second RXDPs into the idle state in response.

4. The apparatus of claim 3, wherein the MAC unit further includes first serializer/deserializer (“SERDES”) units coupled to each of the first TXDPs and RXDPs to place some of the first TXDPs and RXDPs into the idle state during the second operation, and wherein the PHY unit further includes second SERDES units coupled to each of the second TXDPs and RXDPs to place some of the second TXDPs and RXDPs into the idle state during the second operation.

5. The apparatus of claim 4, wherein the bi-directional link comprises a dual lane data path, and wherein the MAC unit further includes third SERDES units to multiplex the first TXDPs and RXDPs onto the dual lane data path, and wherein the PHY unit further includes fourth SERDES units to multiplex the second TXDPs and RXDPs onto the dual lane data path.

6. The apparatus of claim 5, wherein the MAC unit further includes a management data input/output (“MDIO”) unit and the PHY unit further includes control registers coupled to the MDIO unit, the MDIO unit coupled to write control data to the control registers, the PHY unit configured to start up into one of the first operation and the second operation upon reset depending upon the control data.

7. The apparatus of claim 1, wherein the physical medium comprises a four pair twisted conductor.

8. The apparatus of claim 7, wherein the first operation comprises 10GBASE-T transmission across the four pair twisted conductor and the second operation comprises 1000BASE-T transmission across the four pair twisted conductor.

9. A method of operation, comprising:
transmitting a first code on a first transmit path of multiple transmit paths coupling a media access control (“MAC”) unit to a physical (“PHY”) unit, the first code to indicate to the PHY unit that the MAC unit desires to change a link speed to a physical medium;
transmitting a second code on a first receive path of multiple receive paths coupling the PHY unit to the MAC unit in response to the first code, the second code indicating to the MAC unit that the PHY unit is ready to change the link speed; and
changing the link speed.

10. The method of claim 9, wherein changing the link speed comprises:
switching the first transmit path from a high speed state to a slow speed state; and
switching the first receive path from the high speed state to the slow speed state.

11. The method of claim 10, wherein the link speed to the physical medium is 1000BASE-T when the first transmit path and the first receive path are in the slow speed state and wherein the link speed to the physical medium is 10GBASE-T when the first transmit path and the first receive path are in the high speed state.

12. The method of claim 10, wherein changing the link speed further comprises:
placing the multiple transmit paths except the first transmit path in an idle state; and
placing the multiple receive paths except the first receive path in an idle state.

13. The method of claim 9, wherein changing the link speed further comprises:
starting up the multiple transmit paths except the first transmit path from an idle state to a high speed state in response to the second code; and
starting up the multiple receive paths except the first receive path from the idle state to the high speed state in response to the first code.

14. The method of claim 13, wherein changing the link speed further comprises:
switching the first transmit path into the high speed state; and
switching the first receive path into the high speed state.

15. The method of claim 14, wherein changing the link speed further comprises:
transmitting a first synchronize code from the MAC unit to the PHY unit on the first transmit path to synchronize the MAC unit and the PHY unit on the first transmit path in the high speed state; and
transmitting a second synchronize code from the PHY unit to the MAC unit on the first receive path to synchronize the PHY unit and the MAC unit on the first receive path in the high speed state.

16. The method of claim 9, wherein the first code and the second code both comprise a //Q// code defined according to an Institute of Electrical and Electronics Engineers (“IEEE”) 802.3ae-2002 specification.

17. The method of claim 9, wherein the physical medium comprises a four pair twisted conductor.

18. A method of operation, comprising:
transmitting a first code on a first receive path of multiple receive paths coupling a physical (“PHY”) unit to a media access control (“MAC”) unit, the first code to indicate to the MAC unit that the PHY unit is initiating a link speed change to a physical medium;
transmitting a second code on a first transmit path of multiple transmit paths coupling the MAC unit to the PHY unit, the second code indicating to the PHY unit that the MAC unit is ready to change the link speed to the physical medium; and
changing the link speed.

19. The method of claim 18, wherein changing the link speed comprises:
entering the multiple receive paths except the first receive path into an idle state;
switching the first receive path from a high speed state to a slow speed state;
entering the multiple transmit paths except the first transmit path into the idle sate in response to some of the multiple receive paths entering the idle state; and
switching the first transmit path from the high speed state to the slow speed state.

20. The method of claim 18, wherein changing the link speed comprises:
starting up the multiple receive paths, except the first receive path, from an idle state to a high speed state in response to the second code;
starting up the multiple transmit paths, except the first transmit path, from the idle state to the high speed state in response to some of the multiple receive paths starting up;
switching the first receive path from a slow speed state to the high speed state; and
switch the first transmit path from the slow speed sate to the high speed state.

21. The method of claim 18, wherein changing the link speed comprising changing the link speed to the physical medium between a 1 Gbps speed and a 10 Gbps speed.

22. The method of claim 21, wherein the physical medium comprises a four pair twisted conductor and wherein the 1 Gbps speed comprises 1000BASE-T and the 10 Gbps comprises 10GBASE-T.

23. A computer, comprising:
a central processing unit (“CPU”); and
a network interface coupled to the CPU, the network interface to couple the CPU to a physical medium, the network interface comprising:
a media access control (“MAC”) unit to control access to the physical medium, the MAC unit including first transmit data paths (“TXDPs”) and first receive data paths (“RXDPs”);
a physical (“PHY”) unit to couple to the physical medium, the PHY unit including second TXDPs and second RXDPs; and
a bi-directional link coupling the first TXDPs and RXDPs of the MAC unit to the second TXDPs and RXDPs of the PHY unit, respectively, the MAC and PHY units configured to route data along all of the first and second TXDPs and RXDPs during a first operation and to route the data along only one of the first and second TXDPs and only one of the first and second RXDPs during a second operation.

24. The computer of claim 23, wherein the MAC unit includes a first sense unit coupled to each of the first RXDPs to sense when the PHY unit has placed some of the second RXDPs into an idle state and coupled to signal the MAC unit to place some of the first TXDPs into the idle state in response.

25. The computer of claim 24, wherein the PHY unit includes a second sense unit coupled to each of the second TXDPs to sense when the MAC unit has placed some of the first TXDPs into the idle state and coupled to signal the PHY unit to place some of the second RXDPs into the idle state in response.

26. The computer of claim 25, wherein the MAC unit further includes first serializer/deserializer (“SERDES”) units coupled to each of the first TXDPs and RXDPs to place some of the first TXDPs and RXDPs into the idle state during the second operation, and wherein the PHY unit further includes second SERDES units coupled to each of the second TXDPs and RXDPs to place some of the second TXDPs and RXDPs into the idle state during the second operation.

27. The computer of claim 26, wherein the bi-directional link comprises a dual lane bus, and wherein the MAC unit further includes third SERDES units to multiplex the first TXDPs and RXDPs onto the dual lane bus, and wherein the PHY unit further includes fourth SERDES unit to multiplex the second TXDPs and RXDPs onto the dual lane bus.

28. The computer of claim 27, wherein the MAC unit further includes a management data input/output (“MDIO”) unit and the PHY unit further includes control registers coupled to the MDIO unit, the MDIO unit coupled to write control data to the control registers, the PHY unit to start up into one of the first operation and the second operation upon reset depending upon the control data.

29. The computer of claim 23, wherein the physical medium comprises a four pair twisted conductor.

30. The computer of claim 29, wherein the first operation comprises 10GBASE-T transmission across the four pair twisted conductor and the second operation comprises 1000BASE-T transmission across the four pair twisted conductor.
